(19) United States
(12) Patent Application Publication
(10) Pub. No.: US 2014/0178541 A1
(43) Pub. Date: Jun. 26, 2014

(54) Methods of Preventing Gout attack

(71) Applicant: Bo Tran, Chicago, IL (US)

(72) Inventor: Bo Tran, Chicago, IL (US)

(21) Appl. No.: 14/137,554

(22) Filed: Dec. 20, 2013

Related U.S. Application Data
(60) Provisional application No. 61/745,402, filed on Dec. 21, 2012.

(51) Int. Cl. C12H 1/04

(52) U.S. Cl. CPC C12H 1/0432
USPC 426/271; 426/495

(57) ABSTRACT

Methods of preventing gout attacks are disclosed. The methods allow consumption of alcoholic drinks including beer in excess volume without triggering a gout attack. The methods discuss techniques of removing or reducing the levels of amino acid, protein, or purine levels in liquids. Amino acids, proteins, or purines break down forming uric acids which can trigger gout attacks.

### CROSS-REFERENCE TO RELATED APPLICATIONS

This application claims the benefit of U.S. Provisional Patent Application Ser. No. 61/745,402, filed on Dec. 21, 2012, which is hereby incorporated by reference in its entirety.

### BACKGROUND OF THE INVENTION

Human consumption of liquids or alcoholic drinks containing amino acids, proteins or purines can trigger gout attacks. Amino acids, proteins, or purines break down to form uric acid. High concentration of uric acid in the blood stream can precipitate and deposit in the body causing gout attacks. Current practice to prevent gout attacks is to reduce or avoid the consumption of food and drinks containing high levels of proteins or purines.

### BRIEF SUMMARY OF THE INVENTION

The invention provides a method of preventing gout attacks through precipitating and removal of the amino acids, proteins or purines in liquids including alcoholic drinks. A method of preventing gout attack comprising of precipitation and removal of proteins or purines from liquids or food consumed by humans by employing techniques comprising: cold temperature, filtration, and/or increasing ionization strength. A method of preventing gout attacks from consuming beers and alcoholic drinks. A method of preventing gout attacks from consuming beers and alcoholic drinks in excess, greater than two drinks per day. A method of preventing gout attacks comprising precipitating and removal of proteins or purines using high ionic strength water. A method of preventing gout attacks through cold filtering of beers to remove proteins or purines. A method of preventing gout attacks through filtering of beers employing multiple filters in series to remove proteins or purines.

### DETAILED DESCRIPTION OF THE INVENTION

Consumption of liquids or alcoholic drinks containing amino acids, proteins or purines can trigger gout attacks. Amino acids, proteins, or purines break down to form uric acid. High concentration of uric acid in the blood stream can precipitate and deposit in the body causing gout attacks.

Current practice to prevent gout attacks is to reduce or avoid the consumption of food and drinks containing high levels of proteins or purines. The present invention mitigates or eliminates the purines or proteins content; consequently, preventing gout attack. The invention allows consumption of liquids such as beer without triggering gout attacks.

The following definitions are provided to determine how terms used in this application, and in particular how the claims, are to be construed. The organization of the definitions is for convenience only and is not intended to limit any of the definitions to any particular category.

Gout is a form of acute arthritis that results in redness, swelling, pain and tenderness in the joint. When purines break down, they form uric acid, a normally helpful substance that protects blood vessels. Excess amounts, however, can crystallize in the joints, resulting in a gout attack. Avoiding certain types of purine-rich foods, or alcoholic drinks, can reduce the risk of gout attacks and facilitate the healing of existing ones.

Alcoholic drinks such as beer contains high levels of purines. Alcoholic beers can contain in excess of 20 mg of purines per liter. Consumption of beers can lead to a gout attack. Research shows consuming beers can increase the chance of getting gout by 2.5 times. The present invention provides methods of removing purine in liquids including alcoholic drinks.

The present invention provides methods to reduce or prevent gout attacks by lowering the amino acid, protein, and/or purine levels. Purines are a type of protein. Proteins comprise amino acids. Amino acids, protein, or purines can be removed by precipitation and filtering the proteins or purines. High ionic strength of the liquid promotes precipitation of proteins; hence, removal of the protein is feasible through filtration. Cold temperature can promote clumping of proteins, hence enhancing its removal through filtration.

To properly filter the amino acids, proteins, or purines multiple filtration systems set up in series may be required. Filters can include membranes. Common filter media include diatomaceous earth, or kieselguhr, and perlite.

The present invention can reduce purine levels to less than 20 mg per liter in alcoholic beverage; hence, reducing or preventing gout formation.

For test purposes, the inventor consumed several brands of beers, both domestics and foreign beers. The inventor consumed more than two beers per day. Brands include Budweiser (includes light version), Miller (includes light version), Blue Moon, Heineken, Coors, St Pauli Girl, Samuel Adams, Amstel Light, and Kirin. The inventor suffered from gout attacks from drinking each brand of beers after drinking at least two beers per day for several days, with the exception of drinking Coors light beer. The inventor drank Coors light beer for several months and has not experienced any gout attack.

It is known that Coors cold filtered its light beer. Coors' two stage cold activation can further help reduce the purine or protein levels. And the source of water used to make Coors beer may be the Colorado river. The US Environmental Protection Agency in a 1999 report characterized the Colorado river as “ . . . high ionic strength water . . . ”. Other reports list the ionic strength of the Colorado River as averaging 643 ppm (37.3 grains/gal), or 18.8 meq/liter, while the average river ionic strength is 2.1 meq/liter.

Without limited by theory, it is believed applying the method of cold filtration, particularly involving the processing of alcoholic drinks, mitigates and/or prevents gout formation by forming a new liquid formula with less purines or proteins.

Without limited by theory, it is believed increasing the ionic strength of water, particularly involving the processing of alcoholic drinks, mitigates and/or prevents gout formation by forming a new liquid formula with less purines or proteins.

Embodiments of the invention provide: a method of preventing gout attacks through precipitating and removal of the amino acids, proteins or purines in liquids including alcoholic drinks; a method of preventing gout attack comprising of precipitation and removal of proteins or purines employing techniques comprising: cold temperature, filtration, and/or increasing ionization strength; a method of preventing gout attacks from consuming beers and alcoholic drink; a method of preventing gout attacks from consuming beers and alcoholic drinks in excess, greater than two drinks per day; a method of preventing gout attacks comprising precipitating proteins or purines using high ionic strength water and removal of the proteins or purines; a method of preventing gout attacks through cold filtering of beers; and a method of preventing gout attacks through filtering of beers using multiple filters.

The present disclosure is an exemplification of the principles of the invention and is not intended to limit the invention to the particular embodiments illustrated. All patents, patent applications, scientific papers, and any other referenced materials mentioned herein are incorporated by reference in their entirety. Furthermore, the invention encompasses any possible combination of some or all of the various embodiments described herein and incorporated herein.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

All ranges and parameters disclosed herein are understood to encompass any and all subranges subsumed therein, and every number between the endpoints. For example, a stated range of “1 to 10” should be considered to include any and all subranges between (and inclusive of) the minimum value of 1 and the maximum value of 10; that is, all subranges beginning with a minimum value of 1 or more, (e.g. 1 to 6.1), and ending with a maximum value of 10 or less, (e.g. 2.3 to 9.4, 3 to 8, 4 to 7), and finally to each number 1, 2, 3, 4, 5, 6, 7, 8, 9, and 10 contained within the range.

This completes the description of the preferred and alternate embodiments of the invention. Those skilled in the art may recognize other equivalents to the specific embodiment described herein which equivalents are intended to be encompassed by the claims attached hereto.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method of preventing a gout attack comprising precipitation and removal of proteins or purines from food and liquids employing techniques comprising: cold temperature and filtration.

2. The method of claim 1, wherein cold filtration is applied to an alcoholic beverage.

3. The method of claim 2, wherein a purine level of the alcoholic beverage is removed to less than 20 mg per liter employing filtration.

4. The method of claim 3, wherein multiple filters are employed in series to remove proteins or purines.

5. A method of preventing a gout attack comprising precipitation and removal of proteins or purines employing techniques comprising employing high ionic strength water to precipitate and remove proteins or purines from liquids that are consumed by human.

6. The method of claim 5 wherein the water ionic strength is greater than 2.1 meq/liter to precipitate and remove proteins or purines from liquids for human consumption.
